(19) United States
(12) Patent Application Publication
(10) Pub. No.: US 2023/0098547 A1
(43) Pub. Date: Mar. 30, 2023

(54) Wire and Cable Pulling Grip

(71) Applicant: Klein Tools, Inc., Lincolnshire, IL (US)

(72) Inventor: John H. Kargenian, Prospects Heights, IL (US)

(73) Assignee: Klein Tools, Inc., Lincolnshire, IL (US)

(21) Appl. No.: 17/958,143

(22) Filed: Sep. 30, 2022

Related U.S. Application Data
(60) Provisional application No. 63/250,603, filed on Sep. 30, 2021.

(51) Int. Cl. B25J 1/02

(52) U.S. Cl. CPC B25J 1/02

(57) ABSTRACT

A cable grip includes a pulling arm/force member having a tapered or continuously changing cross-section.

### CROSS-REFERENCE TO RELATED APPLICATIONS

This application claims the benefits of Provisional Patent Application Ser. No. 63/250,603 filed Sep. 30, 2021, the entire disclosure of which is incorporated herein by reference.

### BACKGROUND OF THE DISCLOSURE

The present disclosure relates to wire and cable pulling grips. While currently available grips may be very suitable for their intended use, there is always room for improvement.

For example, when installing grips onto cable, in certain applications there is need to lock the grips into an open install position. This position creates an opening defined by the jaw clamp, the body's back wall and the body's cable clamp trough. When grips are configured this way and placed on a cable, they are not secure or stable by themselves and can shift or fall off the cable until the locking mechanism is released to allow the grip to close securely on the cable. When grips are configured to have this open lock install position, the product can be configured to incorporate a mechanism that will cover the opening after it is placed on a cable. This component normally becomes the primary grip lift mechanism and maintains the defined open gap when lifted. When the grip is set on a cable and the mechanism or door is released, it automatically closes the defined opening and creates a barrier for the cable. This current method only addresses the grip from falling off the cable but does not address the stabilization of the grip on the cable or the ability to keep the grip centered on the cable. It is desirable to keep the cable and grip in an ideal alignment until the locking mechanism is release and the grip closes onto the cable.

Another issue is the lift doors in practice are only hinged on one pivot. Through multiple lift cycles the weight of the grip loads on one pivot, creates wear and eventually the axle becomes lose, and the lift door becomes unreliable over time.

Another opportunity is the lift doors are flat and not made to balance the product about multiple axis. The Current lift doors only attempt to balance the assembly about one axis.

A further observation is it is difficult to set grips onto cables, particularly in low lighting applications and even more difficult when using the long insulated hot stick for placement.

A common method for assembling grips is to use rivets as the fasteners and the axles at the joint of the moving parts. It has been observed that over riveting can happen, and as a result, the parts locked up which creates scrap and a loss in production efficiencies.

Yet another issue is that grips are designed to be used on a variety of diameter cables, each with their own pull load requirement. Based on the diameter opening, previously defined by the body cable trough and the jaw clamp, a different loading condition is established at every opening position in the range. For a continually changing opening, there is a continual growing force requirement. Traditional methods are to create a load member to cover the highest load in a particular grip's range creating one continuous cross section capable of handling this upper load. This means these load members are over designed for the lower range forces.

Another observation is that, currently, grips offered in industry have been load tested and the acceptable working load rating is clearly and permanently marked on the grip. It has been observed in practice that these rating are not always respected by users which may cause un-necessary returns and timely investigations. There is an opportunity to create a mechanism, designed to transform itself at predetermine loads which will identify the described event occurred, when inspected.

A further issue is that parallel grips today are designed to have the linkages staggard or off set from each other. This design offers simplistic part construction and assembly, but the off-set linkage creates moments over 3 axes. This approach is inferior when trying to deal with the imposed forces throughout the body as the mechanism is loaded.

As previously outlined, when installing grips onto cable, in certain applications there is need to lock the grips into an open install position. The implementation of this locking feature traditionally uses a notch placed in the pull handle. This notch is placed to capture the outside edge of the slide tower of the main body when the grip is placed into the open install position. This method forces the main components to be designed to accommodate both the non-locking and locking version that results in the overall footprint of the assembly being larger; component angles being stretched open more; jaw capacity being limited; components being heavier than required to handle the loads; the creation of a pinch point for the end user when actuating the lock.

Another issue is that certain cables are very difficult to pull due to the construction and/or materials they are made from. There are cases where cables can withstand high tensile loads but have soft outer strands of material, have insulating or isolating jacket materials or have protective coatings applied. In these cases, it becomes difficult to pull these cables without damaging them when pulling. It is a known practice to use two grips on one cable in multiple location to pull cable for these applications. When using two grips, there is a need to use a balancing hoist to load or pull equally on each grip to properly perform the pull.

A further observation is that grips are normally designed for certain range of cable diameters and cable types. A grip's jaw capacity or range of motion can be designed to accommodate a finite range while maintaining the linkage arrangement that will transfer the pull load from the handle into a suitable jaw clamp force. It is noted that there is an ideal working zone or relationship created by the handle, lever, jaw and body in which once outside that range the assembly's performance will drop off or become unusable. When the grip is designed for the larger cable diameter range, where the smallest intended cable is not small, a typical design will require an end user to bypass the lower cable diameter jaw openings in order to get to starting dimeter, in the stated higher ranges. This is not desirable due to: there being a waste of degrees used in this motion to move the jaw past the small diameters and there being only so many degrees of useable linkage angles between the desired stated upper and lower cable diameter range; the clamp force being based on the derived linkage positions when outside the ideal range can be reduced greatly; the components being larger than necessary to keep the clamping force at required jaw positions and the resulting linkage positions; are grips designed for the higher loads that come with large dimeter cables are much bigger and heavier to be used on small cable diameters.

### BRIEF SUMMARY OF THE DISCLOSURE

The following are examples of structure that could be claimed in this disclosure:

1. A cable pulling grip, comprising:

a main body;

a pair of grip jaws carried on the body and movable relative to each other a clamped position wherein a cable located between the jaws will be clamped by the jaws and an open position wherein a cable located between the jaws is not clamped by the jaws,

a linkage carried on the body and connected to the jaws to force the jaws into clamped engagement with a cable in response to a pulling force applied to the linkage, the linkage comprising:

a pulling arm having a first end connected to a remainder of the linkage, a second end configured to receive the pulling force, and a connection portion extending from the first end to the second end to transfer the pulling force from the second end to the first end, the connection portion being tapered from the second end to the first end.

2. The cable pulling grip of claim 1 wherein the connection portion is curved.

3. The cable pulling grip of claim 1 wherein the linkage further comprises a link having a pivot connection to one of the jaws, a pivot connection to the first end, and a pivot connection to the main body.

4. The cable pulling grip of claim 3 wherein the main body define a slide loop and the connection portion extends through the slide loop.

5. The cable pulling grip of claim 1 wherein the second end has an opening to receive a connector that transmits a pulling force to the pulling arm.

6. A cable pulling grip, comprising:

a main body;

a pair of grip jaws carried on the body and movable relative to each other between a clamped position wherein a cable located between the jaws will be clamped by the jaws and an open position wherein a cable located between the jaws is not clamped by the jaws,

a linkage carried on the body and connected to the jaws to move the jaws from the open position to the clamped position in response to a pulling force applied to the linkage, the linkage comprising:

a pulling arm having a first end connected to a remainder of the linkage, a second end configured to receive the pulling force, and a connection portion extending from the first end to the second end to transfer the pulling force from the second end to the first end, the connection portion having a cross section that continuously increases from a small cross section adjacent the first end to a large cross section adjacent the second end.

7. The cable pulling grip of claim 6 wherein the connection portion is curved.

8. The cable pulling grip of claim 6 wherein the linkage further comprises a lever having a pivot connection to one of the jaws, a pivot connection to the first end, and a pivot connection to the main body.

9. The cable pulling grip of claim 6 wherein the main body define a slide loop and the connection portion extends through the slide loop.

10. The cable pulling grip of claim 1 wherein the second end has an opening to receive a connector that transmits a pulling force to the pulling arm.

11. A cable pulling grip, comprising:

a main body;

a pair of grip jaws carried on the body and movable relative to each other between a clamped position wherein a cable located between the jaws will be clamped by the jaws and an open position wherein a cable located between the jaws is not clamped by the jaws,

a linkage carried on the body and connected to the jaws to move the jaws from the open position to the clamped position in response to a pulling force applied to the linkage;

a fused pin connecting the linkage to one of the jaws, the fused pin configured to deform and retain the jaws in a clamped position in response to a predetermined load on the pin.

12. A cable pulling grip, comprising:

a main body;

a pair of grip jaws carried on the body and movable relative to each other between a clamped position wherein a cable located between the jaws will be clamped by the jaws and an open position wherein a cable located between the jaws is not clamped by the jaws,

a linkage carried on the body and connected to the jaws to move the jaws from the open position to the clamped position in response to a pulling force applied to the linkage;

a fused pin connecting the linkage to one of the jaws, the fused pin configured to shear and retain the jaws in a clamped position in response to a predetermined load on the pin.

It should be understood that the inventive concepts disclosed herein do not require each of the features discussed above, may include any combination of the features discussed, and may include features not specifically discussed above.

### BRIEF SUMMARY OF THE SEVERAL VIEWS OF THE DRAWINGS

FIG. 1 is a perspective view from the above and to the rear of a grip embodying several improved features according to this disclosure, with a pair of grip jaws shown in an open position, a lift door shown in a lift position, and a stabilizing/centering feature shown disengaged from a cable inserted between the jaws;

FIG. 2 is a view taken from the right side of FIG. 1;

FIG. 3 is a view similar to FIG. 1 but with the lift door shown in a closed position and a stabilizing/centering feature engaged with a cable inserted between the grip jaws;

FIG. 4 is a view taken from the right side of FIG. 3;

FIG. 5 is a perspective view from above and to the rear of another embodiment of the grip showing an additional stabilizing/centering feature extending rearward from the lift door, with the grip jaws in an open position, the lift door in a lift position, and the stabilizing/centering features shown disengaged from the cable inserted between the jaws;

FIG. 6 is a view similar to FIG. 5, but showing the stabilizing/centering features engaged with the cable and the lift door in a closed position;

FIG. 7 is a perspective view from above and to the rear of another embodiment of the grip showing an additional stabilizing/centering feature extending forward from the lift door, with the grip jaws in an open position, the lift door in a lift position, and the stabilizing/centering features shown disengaged from the cable inserted between the jaws;

FIG. 8 is a view similar to FIG. 7 but showing the lift door in a closed position and the stabilizing/centering features engaged with the cable;

FIG. 9 is a perspective view from above and to the front of the grip embodiment of FIGS. 7 and 8, again showing the lift door in a closed position and the stabilizing/centering features engaged with the cable;

FIG. 10 is a perspective view from above and to the front showing another embodiment of a grip having two of the stabilizing/centering features engaged with a cable;

FIG. 11 is a left elevation view of a pulling arm component of the grips disclosed herein;

FIG. 12 is a left side elevation view of a grip including the pulling arm of FIG. 11 showing a pair of grip jaws positioned to grip a relatively small diameter cable;

FIG. 13 is a view similar to FIG. 12 by showing the pair of grip jaws positioned to grip a relatively large diameter cable;

FIG. 14 is a perspective view from above and to the front of the grip of FIGS. 12 and 13 but including a fused jaw pin;

FIG. 15 is an enlarged section view taken from FIG. 14;

FIG. 16 is an enlarged view taken from the left side of FIG. 14;

FIG. 17 is an enlarged view of the fused jaw pin of FIGS. 14-16;

FIG. 18 is a view similar to FIG. 17 but showing the fused jaw pin in a deformed state;

FIG. 19 is a rear elevation view of a grip illustrating a prior art linkage configuration;

FIG. 20 is a section view of the grip of FIG. 19,

FIG. 21 is a left side elevation view of the grip of FIGS. 19 and 20 illustrating a moment about an axis created by a pulling force applied to the grip;

FIG. 22 is a bottom view of the grip of FIGS. 19-21 illustrating another moment about another axis created by the pulling force applied to the grip;

FIG. 23 is a view similar to FIG. 19 but showing yet another moment about yet another axis created by the pulling force applied to the grip;

FIG. 24 is a front elevation view of a grip having an in-line linkage arrangement according to this disclosure;

FIG. 25 is a section view of the grip of FIG. 24;

FIG. 26 is a left side elevation view of the grip of FIGS. 24 and 25 illustrating the only moment about an axis created by a pulling force on the grip;

FIG. 27 is a bottom view of the grip of FIGS. 24-26 showing the absence of a moment in response to the pulling force on the grip;

FIG. 28 is rear elevation view of the grip of FIGS. 24-27, again showing the absence of a moment in response to the pulling force on the grip;

FIG. 29 is an enlarged left side elevation showing a limited part of a pulling arm incorporating a stop surface according to this disclosure;

FIG. 30 is an enlarged section view showing part of a main body incorporating a stop surface inside a slide loop according to this disclosure;

FIG. 31 is an enlarged section view of a grip showing the stop surfaces of FIGS. 29 and 30 engaged with each other according to this disclosure;

FIG. 32 is a left side elevation view of another embodiment of the grip with the jaws shown in an open position;

FIG. 33 is a perspective view from the front and above of the grip of FIG. 32;

FIG. 34 is a right side elevation view of the grip of FIGS. 32 and 33;

FIG. 35 is a left side elevation view of another grip embodiment that provides multiple pairs of jaws according to this disclosure;

FIG. 36 is a perspective view from the front and above of the grip of FIG. 35;

FIG. 37 is a perspective view from the front, left and below of another grip embodiment according to this disclosure;

FIG. 38 is a perspective view from the front, right and below of the grip of FIG. 37;

FIG. 39 is a left side elevation view of another grip embodiment according to this disclosure;

FIG. 40 is a left side elevation view of yet another grip embodiment according to this disclosure;

FIG. 41 is a perspective view from the front, left and below of a jaw of the grip of FIG. 40;

FIG. 42 is a perspective view of a rivet structure for use in a grip according to this disclosure;

FIG. 43 is a perspective view of the rivet structure of FIG. 42 with the addition of a pivoting component of a grip to be secured by the rivet structure;

FIG. 44 is a side elevation view of the rivet structure and pivoting component of FIG. 43 with the addition of a washer/plate component that is used to form a final rivet connection;

FIG. 45 is a view similar to FIG. 44 but showing the rivet structure deformed to form a final rivet connection;

FIG. 46 is a perspective view of the final rivet connection of FIG. 45;

FIG. 47 is a perspective view from the front, right and above of the grip of FIGS. 1-4;

FIG. 48 is a left side elevation view of the grip of FIGS. 1-4, and 47; and

FIG. 49 is a rear elevation view of the grip of FIGS. 1-4, 47, and 48.

### DETAILED DESCRIPTION OF PREFERRED EMBODIMENTS

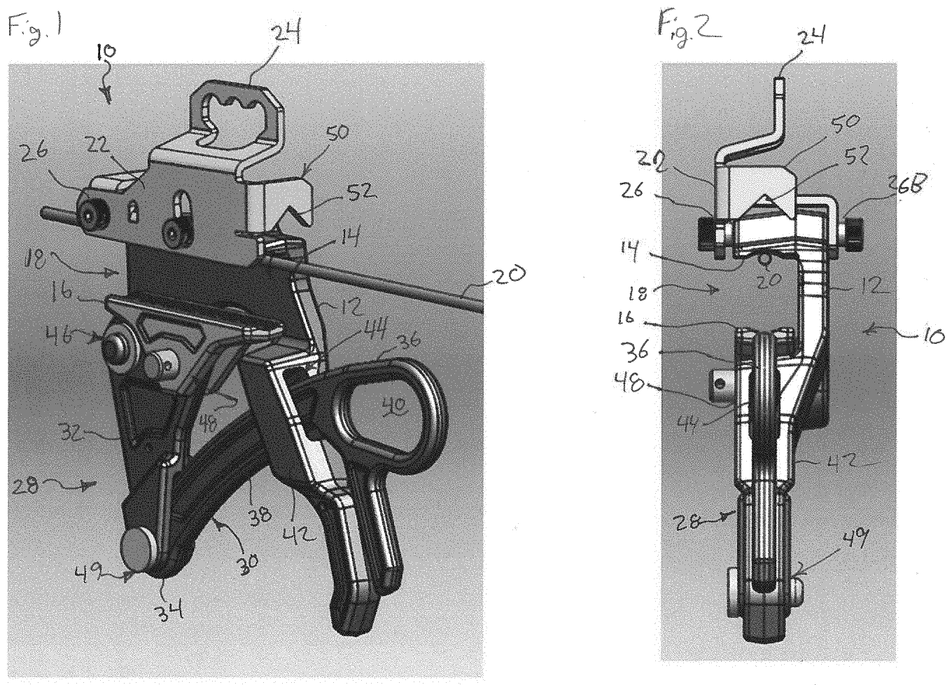

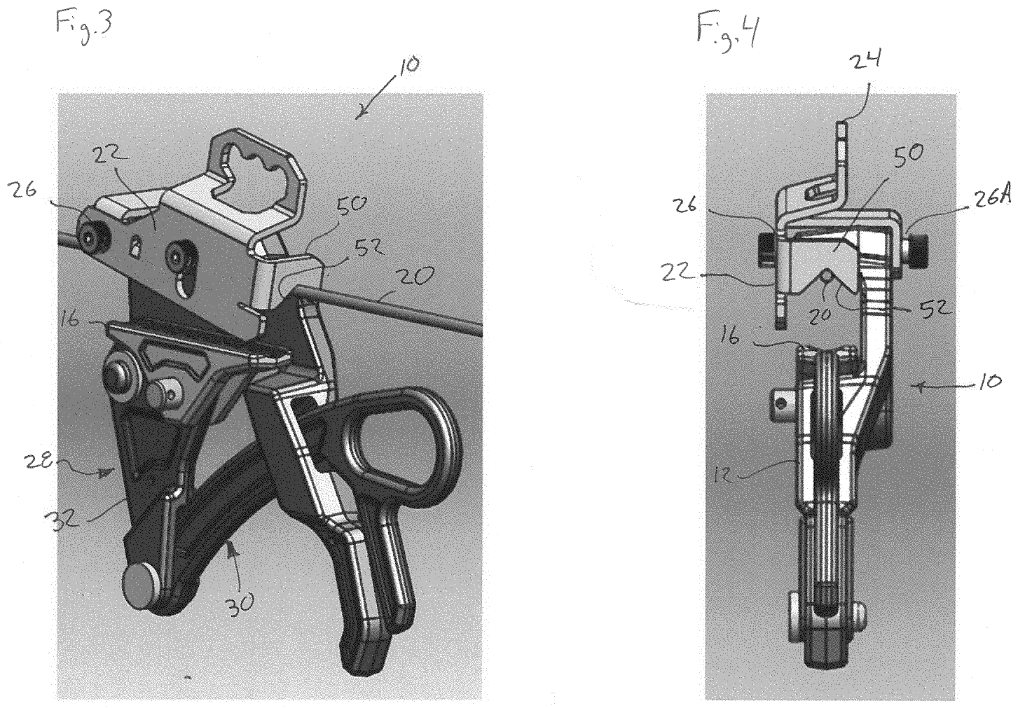

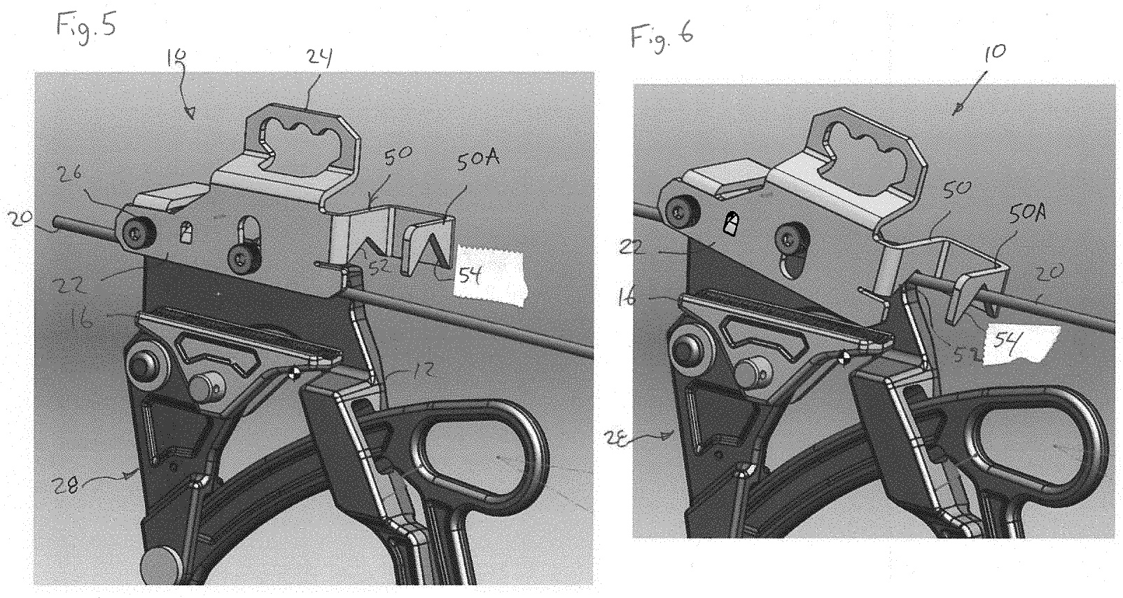

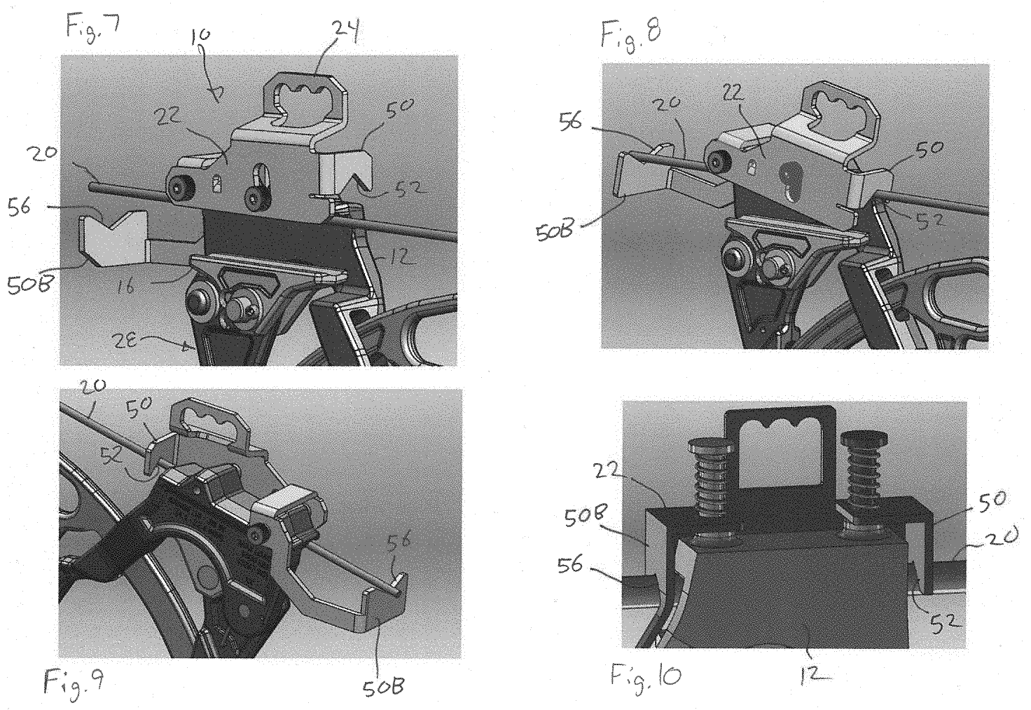

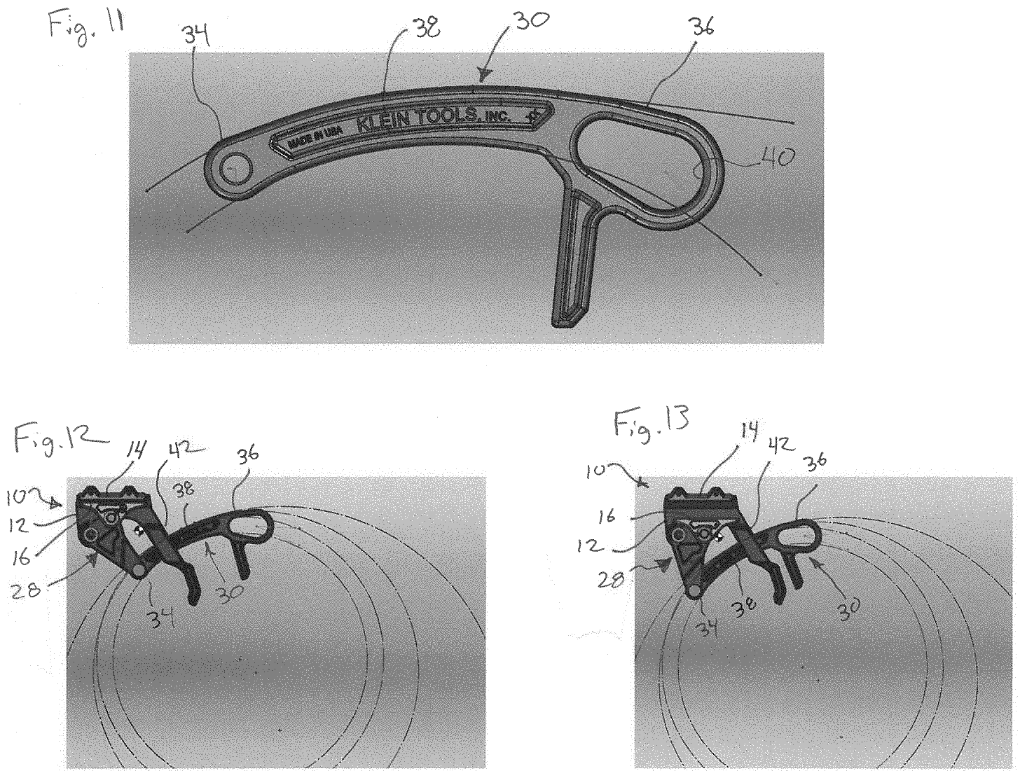

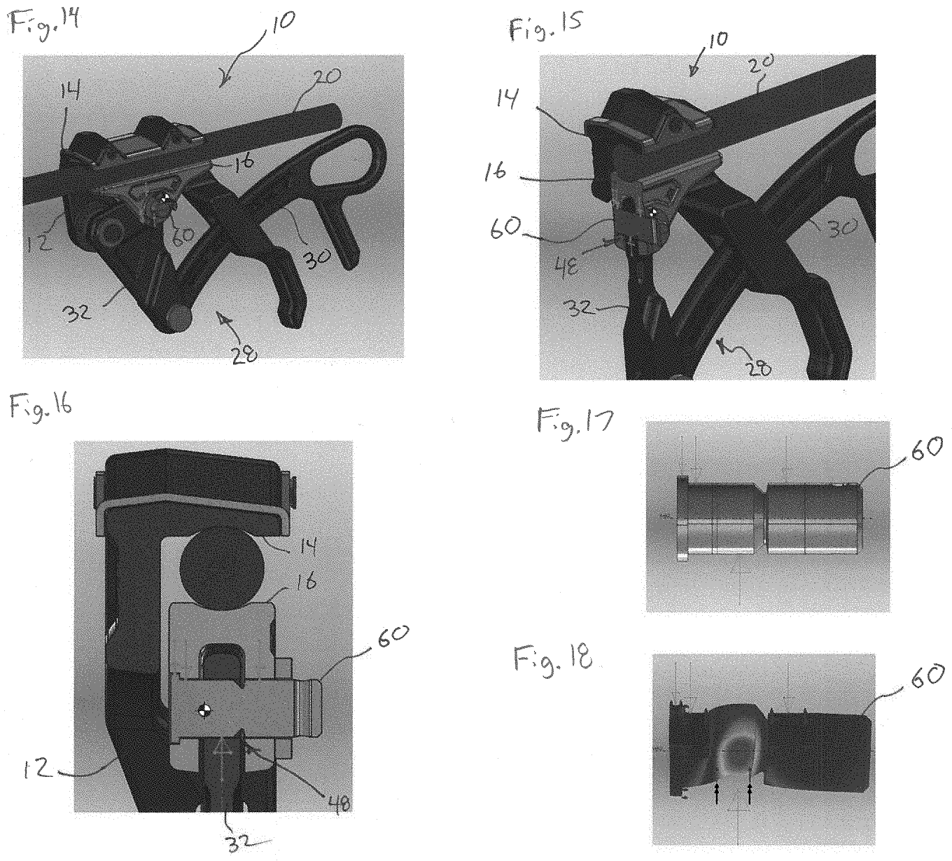

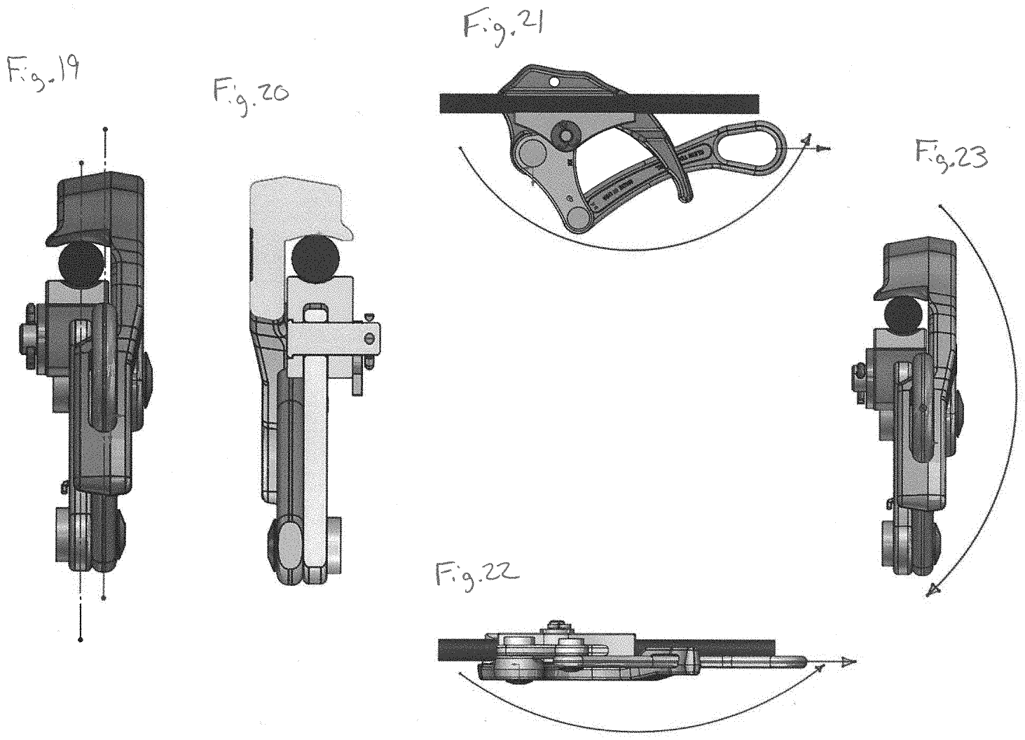

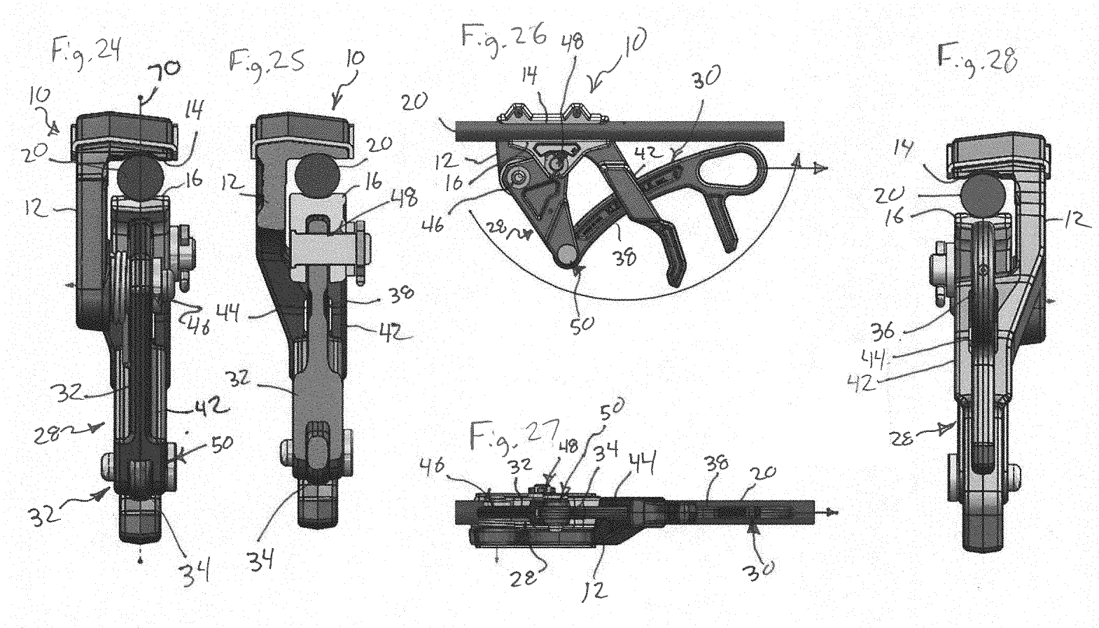

As best seen in FIGS. 1-4, a grip 10 includes a main body 12, a pair of grip jaws 14 and 16 carried on the body 12 moveable relative to each other between an open position wherein the jaws 14, 16 define an opening 18 through which a cable 20 can be inserted between the jaws 14, 16 and removed from between the jaws 14, 16, and gripping positions wherein the jaws 14, 16 grip a cable 20 that has been inserted between the jaws 14, 16. The grip 10 further includes a lift door 22 mounted on the main body 12 to move between a closed position (FIGS. 3 and 4) wherein the lift door 22 blocks the opening 18 to restrict insertion and removal of a cable 20 and a lift position (FIGS. 1 and 2) wherein the lift door 22 does not restrict insertion and removal of a cable 20. The lift door 22 includes a lift tab 24 and is mounted by a hinge 26 to pivot between the closed and open positions. The grip 10 further includes a linkage 28 carried on the body 12 and connected to the jaw 16 to move the jaw 16 from the open position to the clamped position in response to a pulling force applied to the linkage 28. The linkage 28 includes a pulling arm 30 and a lever 32. The pulling arm 30 has a first end 34, a second end 36 configured to receive the pulling force, and a connection portion 38 extending from the first end 34 to the second end 36 to transfer the pulling force from the second end 36 to the first end 34. The second end 36 includes an opening or eye 40 that can receive a connector that applies the pulling force to the second end 32. The main body includes slide tower 42 that defines a slide loop 44 through which the connection portion 38 of the pulling arm 30 extends. The lever 32 has a first pivot connection 46 connecting the lever 32 to the main body 12, a second pivot connection 48 connecting the lever 32 to the jaw 16, and a third pivot connection 49 connecting the lever 32 to the first end 34 of the pulling arm 30. While most conventional, known pulling grips will, in some form, include some or all of the features 12, 14, 16, 22, 24, 26, 28, 30, 32, 40, 42, 44, 46, 48, and 49; this disclosure shows and discusses improvements to several of these features and the details of these improvements shown in the illustrated embodiments and discussed herein are not provided in conventional, known pulling grips, as will be explained in more detail below.

FIGS. 1-4 illustrate an improvement in the form of a centering and stabilization structure 50 that address the stabilization and centering of the grip 10 discussed in the Background Section of this disclosure. As can be seen in FIGS. 1 and 2, the structure 50 is incorporated as part of the lift door 22 and is illustrated a being a one-piece construction with the lift door 22. The structure 50 interacts with the cable 20 keeping it centered and the assembly 10 more stable on the cable 20 when the grip 10 is placed on the cable 20 and the lift door 22 is released, as best seen in FIGS. 3 and 4. In the illustrated embodiment, a V-notch 52 is used for the structure 50. It is to be noted that the stability and centering can be enhanced by altering the distance of the V-notch placement from the pivot/hinge 26 of the lift door 22.

As best seen in FIGS. 5 and 6, a more stable platform will incorporate multiple stabilization structures 50, with the illustrated embodiment showing an additional structure 50A with an additional v-notch 54.

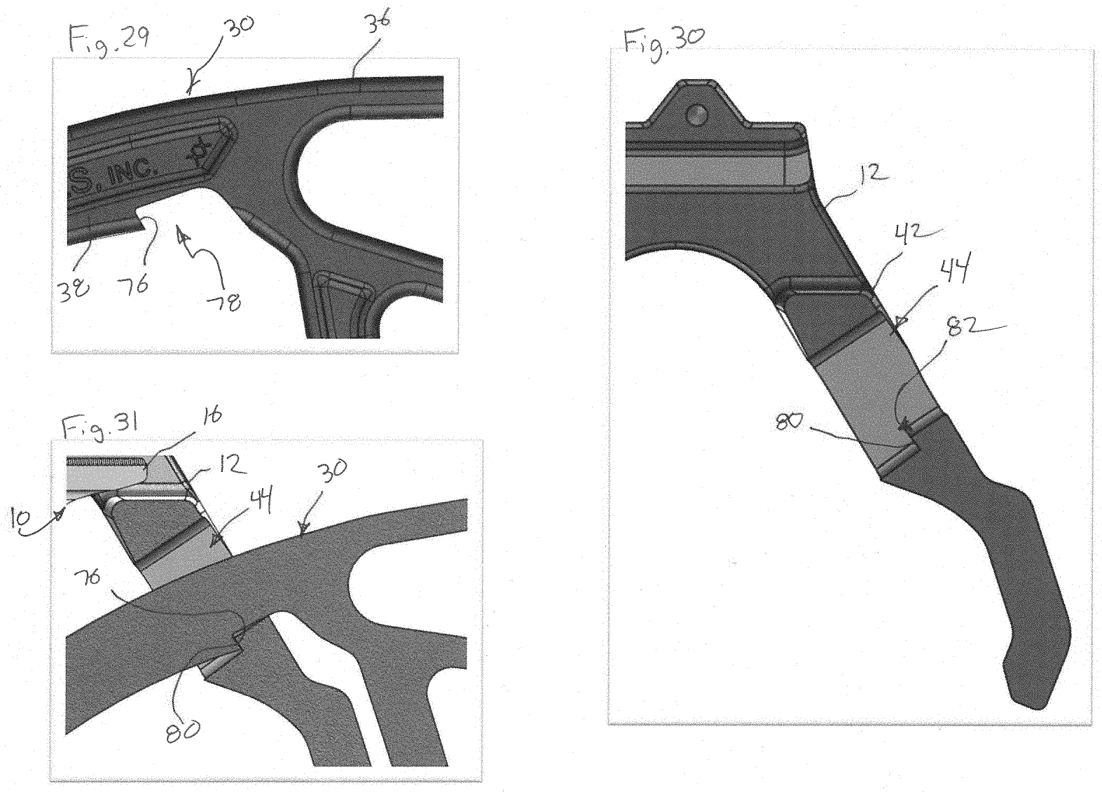

As best seen in FIGS. 7-10, an even more stable platform will incorporate a front stabilization feature 50B, with the illustrated embodiments having an additional v-notch 56. As can be seen in the illustrated embodiment of FIGS. 7-9, the notch 50 and the notch 56 are located to engage oppositely facing sides of the cable 20, whereas the notches 50 and 56 of the embodiment illustrated in FIG. 10 engage the same side of the cable 20. Additionally, it should be noted that the embodiment illustrated in FIG. 10 provides a different mount structure connecting the lift door 22 to the body 12, to provide a vertical floating lift door 22.

As discussed in the Background Section of this disclosure, grips are designed to be used on a variety of diameter cables, each with their own pull load requirement. Based on the diameter opening, previously defined by the body cable trough and the Jaw clamp, a different loading condition is established at every opening position in the range. For a continually changing opening, there is a continual growing force requirement and traditional methods are to create a load member/pulling arm to cover the highest load in a particular grip's range creating one continuous cross section capable of handling this upper load. This means the load member/pulling arm are over designed for the lower range forces. The embodiments of the grip 10 illustrated in 11-13 seeks to reduce the material and weight while maintaining the load requirement at a particular opening by providing a pulling arm 30 having a connection portion 38 with a continually changing cross section where the small cross section (shown adjacent the first end 34) is utilized on the small opening that requiring low loads, as best seen in FIG. 12) and gradually increased to the large cross section (shown adjacent the second end 36) configured at the large openings which require large loads, as best seen in FIG. 13.

As discussed in the Background Section of this disclosure, grips currently offered in industry are load tested and the acceptable working load rating is clearly and permanently marked on the grip. It has been observed that these rating are not always respected by users, which may cause un-necessary returns and timely investigations. There is an opportunity to create a mechanism, designed to transform itself at predetermine loads, which will identify the described event occurred when inspected. The embodiments of the grip 10 illustrated in FIGS. 14-18 accomplish this by providing a fused jaw pin 60 that will deform as desired when a desired overload value is reached. The ideal pin design 60 will deform and lock the assembly 16, 32 in a clamped position controlling the overall situation until the pull load is released. In this version, depending on the fused load, the pin 60 may or may not be replaced to reset the grip to working status. As an alternative, the pin 60 can be designed to fully shear to create the same fused functionality, controlling the clamping lockup, but rendering the assembly inactive.

As discussed in the Background Section of this disclosure, parallel grips today are designed to have the linkages staggard or off set from each other, as illustrated in FIGS. 19 and 20. This design offers simplistic part construction and assembly, but the off-set linkage creates moments over 3 axes, as illustrated in FIGS. 21-23. This approach is inferior when trying to deal with the imposed forces throughout the body as the mechanism is loaded. It should be noted that the FIGS. 19-23 are only attempting to illustrate a prior art arrangement of an offset linkage, with other features/components not necessarily being illustrated as prior art.

The embodiment of the grip 10 best illustrated in FIGS. 24-28 provide an in-line linkage that address the twisting and deformation over the 3 axis that occurs with an offset linkage approach such as shown in FIGS. 19-23. The in-line linkage reduces the moments to 1 axis, as best seen in FIGS. 26-28, and with only negligibly more complex part construction and assembly. Accordingly, the in-line linkage of FIGS. 24-28 is superior when trying to deal with the same loading and simplifies the imposed forces throughout the body 12.

As best seen in FIG. 24, the slide loop 42 is centered on a first axis 70, with the longitudinal axis of the cable 20 also centered on the first axis when the cable 20 is clamped by the jaws 14 and 16. As best seen in FIGS. 24, 25, 27 and 28, the first end 34, the second end 36 and the connection portion 38 of the pulling arm 30 are all centered on the axis 70.

As previously outlined in the Background Section of this disclosure, when installing grips onto cable, in certain applications there is need to lock the grips into an open install position. The implementation of this locking feature traditionally uses a notch placed in the pull handle to capture the outside edge of the slide tower of the main body when the grip is placed into the open install position. This method forces the main components to be designed to accommodate both the non-locking and locking version in that results in the overall footprint of the assembly is larger, the component angles being stretched open more, the jaw capacity being limited, and the components being heavier than required to handle the loads. It also has been observed that this method creates a pinch point for the end user when actuating the lock. As discussed below, a new approach is implemented to addresses all the issues found in the current method of locking a grip in the open install position.

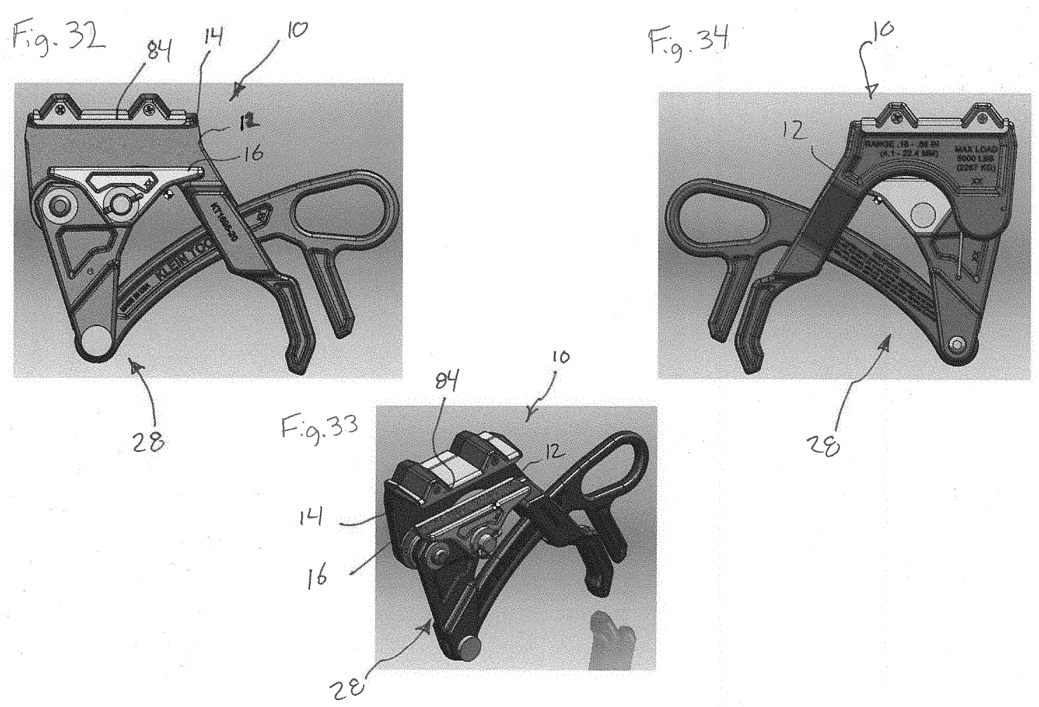

As best seen in FIGS. 29-31, by creating a purposeful internal lock ledge, inside the slide loop of the slider tower, the grip design can have: a reduced footprint; optimized actuation angles; larger jaw capacity (larger range of motion); smaller/lighter components; and a reduced/eliminated pinch point potential as the lock notch of the handle moves back to engage with the lock ledge. As best seen in FIG. 29, a lock surface 76 is provided on the pulling arm adjacent the second end 30. In the illustrated embodiment, the lock surface 76 is defined my a notch 78 formed in the connection portion 38. Another lock surface 80 is located inside the slide loop 44 of the main body 12. In the illustrated embodiment, the lock surface 80 is defined by a lock ledge 82 located inside the slide loop 44. As best seen in FIG. 31, the stop surfaces 76 and 80 engage each other to retain the jaw 16 in the open position.

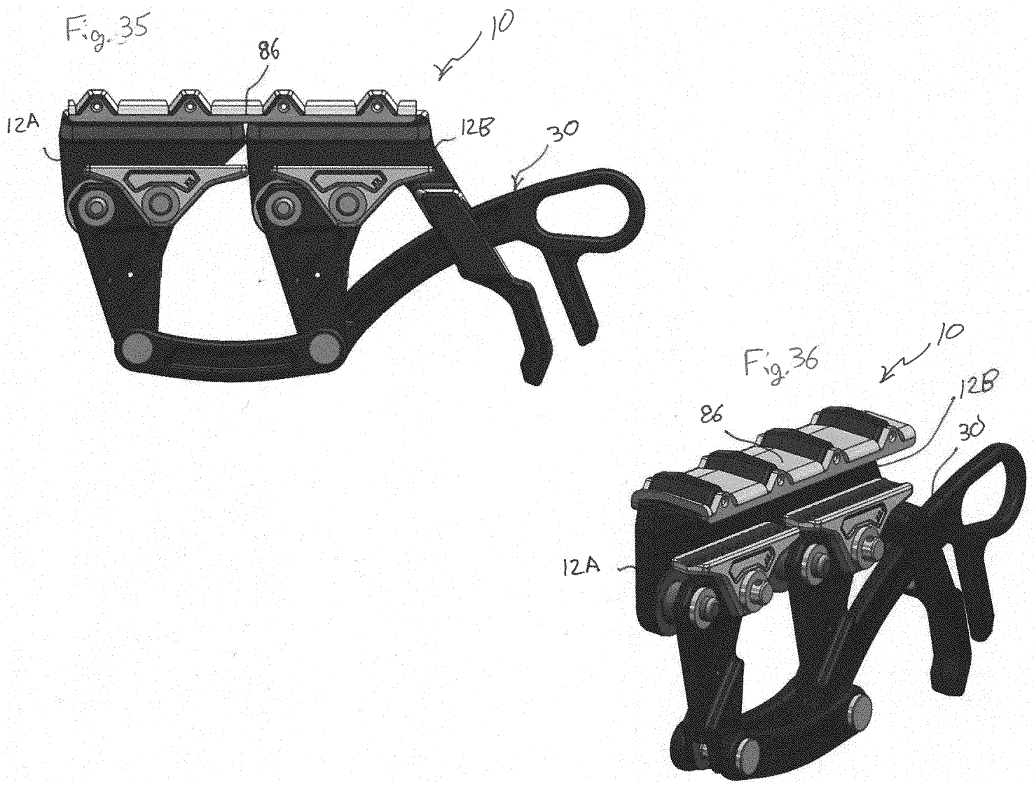

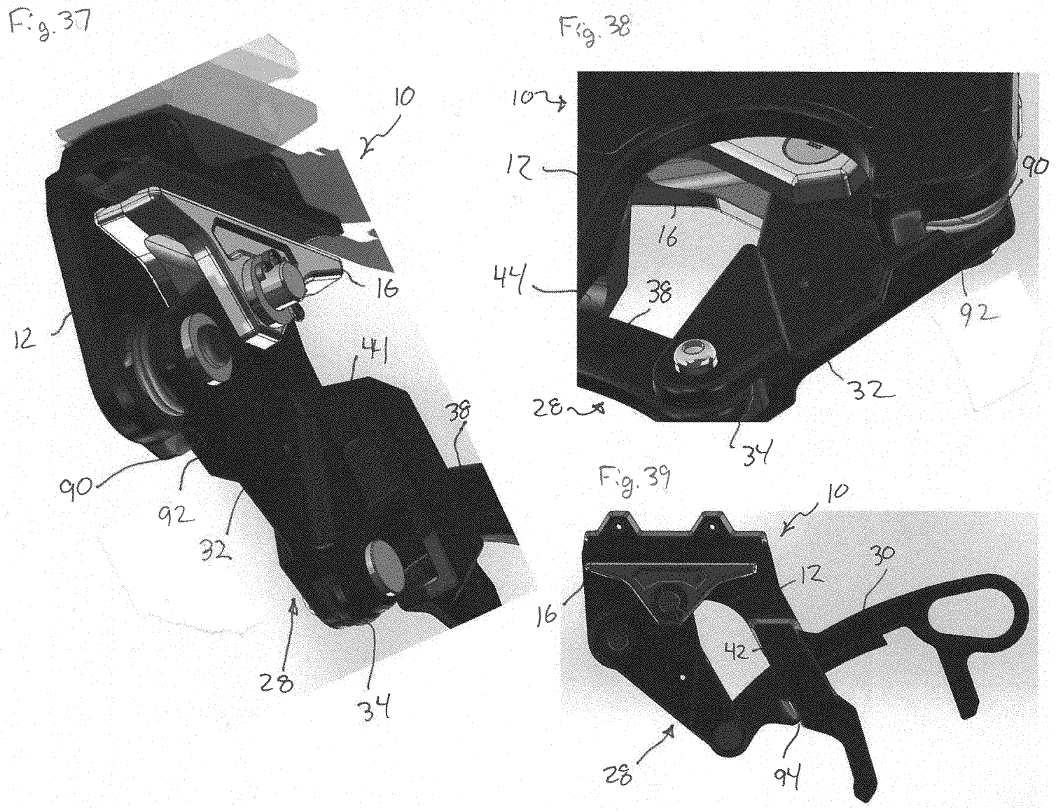

Current practice of grip producers is to utilize one color system on all the parts creating a one-dimensional product, from a look and performance aspect. One feature of the grips 10 disclosed herein is the use of multi color components to create: a unique product look and to create a visual targeting system for the end user, easing placement on a cable. Specifically, as shown in the illustrated grips 10, the light/metallic/highly visible/reflecting materials or finishes are intended to be illustrated in the drawings for the lift door 22 and the jaw 16 and outer surfaces 84 adjacent the jaw 14, with the body 12 having a dark backfield color that is also shown for the linkage 28. When the jaws 14 and 16 of the grips 10 are put into the open, the body's back wall and the body's cable trough contrast with the materials of the lift door 22 and the jaw 16, which creates a visual guide or targeting system for all install applications and various ambient lighting conditions, as best illustrated in FIGS. 32 and 33, but as also clearly shown in FIGS. 1, 5,7, and 13. It should be understood that this targeting system can be used for grips that do not lock in an open position and for other grips that can be locked in the open position. Furthermore, there is an opportunity to add to the back field a highly visual or reflective material to create the targeting system for currently available grips without altering component color.

As discussed above in the Background Section, certain cables are very difficult to pull due to the construction and/or materials they are made from. There are cases where cables can withstand high tensile loads but have soft outer strands of material, have insulating or isolating jacket materials or have protective coatings applied. In these cases, it becomes difficult to pull these cables without damaging them when pulling. It is a known practice to use two grips on one cable in multiple location to pull cable for these applications. When using two grips, there is a need to use a balancing hoist to load or pull equally on each grip to properly perform the pull. FIGS. 35 and 36 illustrate a solution to this problem by providing multiple clamping locations in one assembly according to this disclosure.

More specifically, FIGS. 35 and 36 illustrate a grip 10 that utilizes modified grip bodies 12A and 12B attached with a bracket 86, linked or chained together in series to operate as one unit. The new assembly will act as one grip 10 that pulls in multiple locations to distribute the load with one pull handle 30, eliminating the need of a balancing hoist. This method can be expanded to as many grip nodes, as necessary. It is also possible to alter the linkages per grip node to have a different pull characteristic than another adjacent node. It is also possible to incorporate axial pivoting linkages. This would allow to place one of the clamp nodes opposite or reversed to another, allowing the grip to go on to cable from both directions versus the traditional one-sided openings. This would require an additional locking bracket at the top. There is an opportunity to create a linkable/configurable system where the secondary nodes are allowed to be added on to the base primary node/grip when required by application.

As previously discussed above in the Background Section, grips are normally designed for certain range of cable diameters and cable types. In this regard, a grip's jaw capacity or range of motion can be designed to accommodate a finite range while maintaining the linkage arrangement that will transfer the pull load from the handle into a suitable jaw clamp force. It is noted that there is an ideal working zone or relationship created by the handle, lever, jaw and body in which once outside that range the assembly's performance will drop off or become unusable. When the grip is designed for the larger cable diameter range, where the smallest intended cable is not small, a typical design will require an end user to bypass the lower cable diameter jaw openings in order to get to starting dimeter, in the stated higher ranges. This is not desirable due to: a waste of degrees used in this motion to move the jaw past the small diameters; the clamp force based on the derived linkage positions when outside the ideal range potentially being reduced greatly; the components becoming larger than necessary to keep the clamping force at required jaw positions and the resulting linkage positions; and grips designed for the higher loads that come with large dimeter cables being much bigger and heavier to be used on small cable diameters.

As best seen in FIGS. 37 and 38, these issues are addressed by providing a physical stop or zero point for the jaw 16 in the “closed position” that targets the smallest diameter of the large cable diameter range, thereby eliminating the unnecessary motion, establishing the ideal linkage working range, and safeguarding clamping force.

More specifically, FIGS. 37 and 38 show a grip 10 having a physical stop 90 on the body 12 and a corresponding stop 92 on the lever 32 in a desired location that creates a new zero point of the linkage 28 to maximize the opening range instead of the fully closed jaw position. Pads on body 12 and lever 32 butt against each other acting as a stop to prevent further jaw motion. FIG. 39 shows another embodiment of the grip 10 using the body 12 and a corresponding stop 94 on the handle 30 in a desired location to create a new zero point of the linkage to maximize the opening range instead of the fully closed jaw position.

Due to the advancement in cable types and construction materials, a need for different griping options evolved. New coatings, cable treatments and a variety of surface harnesses created this challenge that cannot be solved by one grip style that can pull them all. A practice used by in some currently available grips is to use a variety of surface treatments to, one or both, of the gripping surfaces of the grip. The aggressiveness of the surface treatment selected is in direct correlation to the needs of the cable type. It is recognized that within one grip family, it can have multiple surface finishes to cover a large range of cables. This created the need for a user to be enabled to distinguish between grips intended for different types of cables.

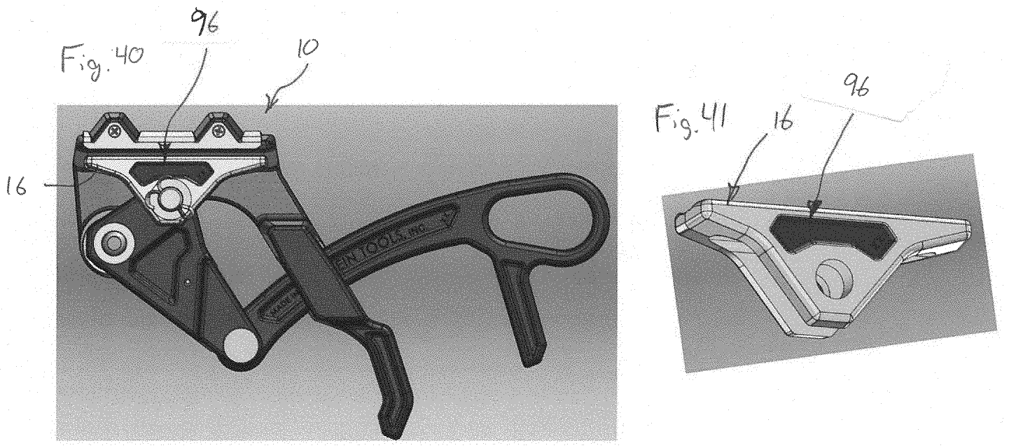

As best seen in FIGS. 40 and 41, a preferred embodiment of a grip 10 uses a color-coding method wherein a color is applied to an easily visible part of the grip 10, such as on an outwardly facing surface of the jaw 16, such as shown by the colored zone 96 shown in FIGS. 40 and 41. It should be clear that any type of visual indicator such as labeling the product or utilizing a text-based approach is within the scope of this feature and that it is not limited to color. This a coding scheme can be used to identify the aggressiveness/friction/surface finish of choice used on the grip to create an easily identifiable visual distinction between grip types.

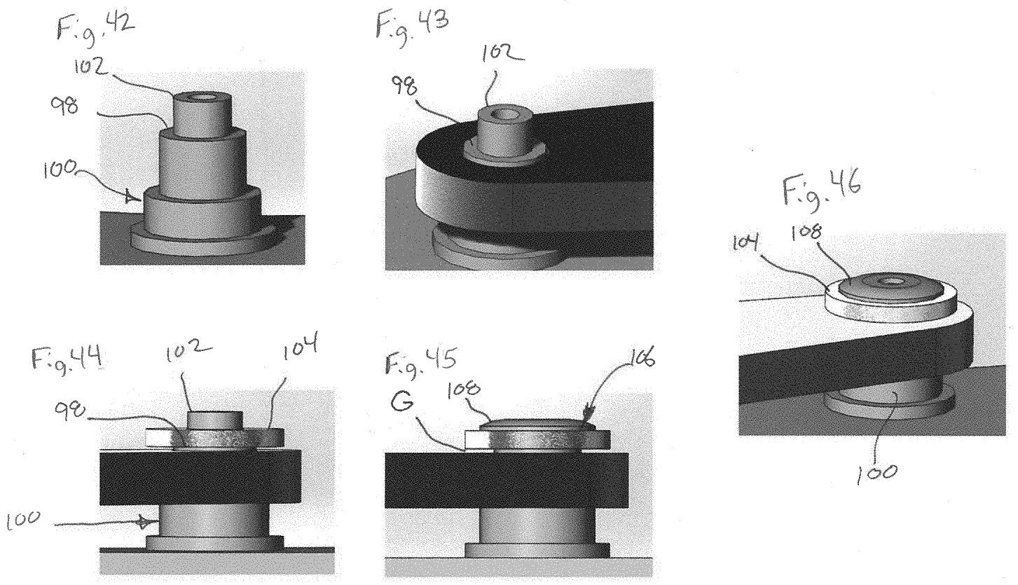

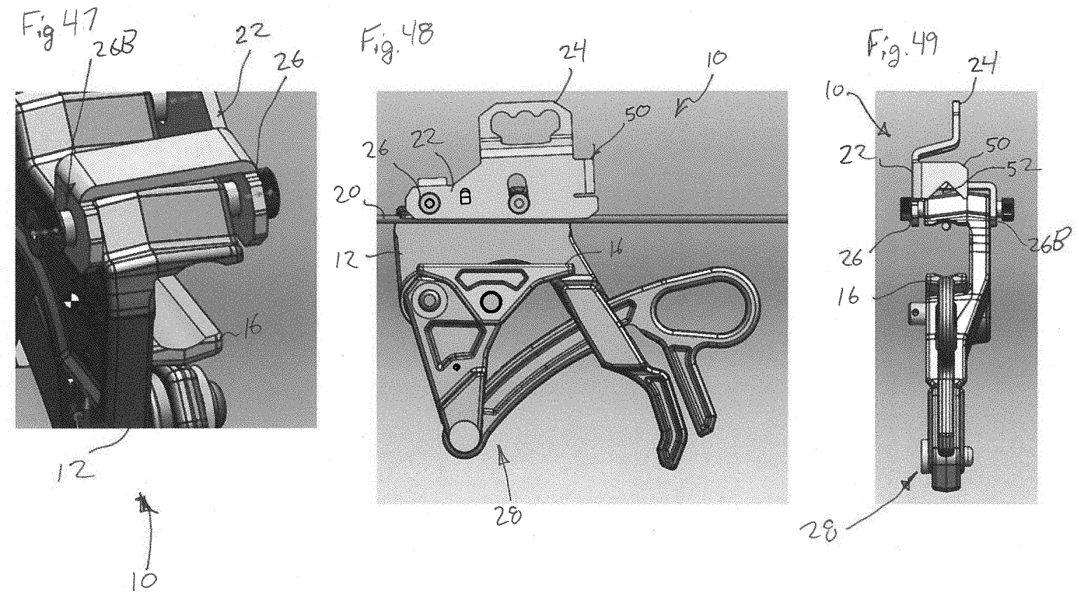

A common method for assembling grips is to use rivets as the fasteners and the axles at the joint of the moving parts. It has been observed that over riveting can happen, and as a result, the parts locked up which creates scrap and a loss in production efficiencies. FIGS. 42-46 illustrate a solution to this issue by adding a positive step or shoulder 98 on the rivet body 100, reducing the size of the rivet tip 102. This will create a localized riveting zone on the rivet. A spacer, washer, or compression plate 104 can be used in the riveting zone can accept the material swell in the localized zone 106 while setting a compression plane for the rivet material 108 to squeeze against, maintaining a desired gap G between the moving parts. The riveting zone is designed to fall outside of the moving assembly.

As best seen in FIGS. 47-49, the grips 10 incorporate a second hinge 26B on the far side of the assembly to help share the lift burden that is typically born by one hinge.

As best seen in FIG. 49, another improvement is provided by locating the lift tab 24 over the assembly's center of mass (most important when in the open lock position), the feature can balance the assembly on both x and y axis (front view and side view).

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

All references, including publications, patent applications, and patents, cited herein are hereby incorporated by reference to the same extent as if each reference were individually and specifically indicated to be incorporated by reference and were set forth in its entirety herein.

What is claimed is:

1. A cable pulling grip, comprising:
a main body;
a pair of grip jaws carried on the body and movable relative to each other a clamped position wherein a cable located between the jaws will be clamped by the jaws and an open position wherein a cable located between the jaws is not clamped by the jaws,
a linkage carried on the body and connected to the jaws to force the jaws into clamped engagement with a cable in response to a pulling force applied to the linkage, the linkage comprising:
a pulling arm having a first end connected to a remainder of the linkage, a second end configured to receive the pulling force, and a connection portion extending from the first end to the second end to transfer the pulling force from the second end to the first end, the connection portion being tapered from the second end to the first end.

2. The cable pulling grip of claim 1 wherein the connection portion is curved.

3. The cable pulling grip of claim 1 wherein the linkage further comprises a link having a pivot connection to one of the jaws, a pivot connection to the first end, and a pivot connection to the main body.

4. The cable pulling grip of claim 3 wherein the main body define a slide loop and the connection portion extends through the slide loop.

5. The cable pulling grip of claim 1 wherein the second end has an opening to receive a connector that transmits a pulling force to the pulling arm.

6. A cable pulling grip, comprising:
a main body;
a pair of grip jaws carried on the body and movable relative to each other between a clamped position wherein a cable located between the jaws will be clamped by the jaws and an open position wherein a cable located between the jaws is not clamped by the jaws,
a linkage carried on the body and connected to the jaws to move the jaws from the open position to the clamped position in response to a pulling force applied to the linkage, the linkage comprising:
a pulling arm having a first end connected to a remainder of the linkage, a second end configured to receive the pulling force, and a connection portion extending from the first end to the second end to transfer the pulling force from the second end to the first end, the connection portion having a cross section that continuously increases from a small cross section adjacent the first end to a large cross section adjacent the second end.

7. The cable pulling grip of claim 6 wherein the connection portion is curved.

8. The cable pulling grip of claim 6 wherein the linkage further comprises a lever having a pivot connection to one of the jaws, a pivot connection to the first end, and a pivot connection to the main body.

9. The cable pulling grip of claim 6 wherein the main body define a slide loop and the connection portion extends through the slide loop.

10. The cable pulling grip of claim 1 wherein the second end has an opening to receive a connector that transmits a pulling force to the pulling arm.
